(19) United States
(12) Patent Application Publication
(10) Pub. No.: US 2017/0220999 A1
(43) Pub. Date: Aug. 3, 2017

(54) TECHNIQUES FOR DOCUMENT MANAGEMENT WORKFLOWS

(71) Applicant: Adobe Systems Incorporated, San Jose, CA (US)

(72) Inventors: Benjamin Follis, London (GB); Christopher Laine, San Jose, CA (US)

(21) Appl. No.: 15/013,252

(22) Filed: Feb. 2, 2016

(51) Int. Cl. G06Q 10/10

(52) U.S. Cl. CPC G06Q 10/103

(57) ABSTRACT

This disclosure relates to controlling access to document information (e.g., signatures, an audit trail, etc.) related to a document management project. The method may include receiving user-specified input related to the document management project that comprises a first set of attributes that define a first set of tasks and accessible information of a first workflow and a second set of attributes that define a second set of tasks and accessible information of a second workflow. A first document is provided to a first individual by executing one or more instructions of the first workflow according to the first set of attributes. A second document is provided to a second individual by executing one or more instructions of the first workflow according to the first set of attributes. Progress of the first workflow execution and the second workflow execution is tracked. Information is provided related to the tracked progress.

### TECHNICAL FIELD

This disclosure relates generally to computer-implemented methods and systems for providing a number of workflows relating to document management project.

### BACKGROUND

It has become commonplace for documents to be transferred between parties electronically using a document management system. In some contexts, such as contract execution for example, document management presents a number of challenges. For example, a document (e.g., a contract) may include a collection of documents that individually require a signature and/or document review from a number of individuals (e.g., a customer, a subcontractor, an approval manager, etc.). Current document management techniques allow for a document originator to provide the electronic document (e.g., the contract) to one or more parties by enabling the originator to designate one or more recipients (e.g., an email address accessible to an individual for which a signature and/or document review is desired). Upon delivery, the recipient reviews and electronically signs the document and provides the signed document to the originator.

Current techniques allow recipients of the document to access confidential information by allowing a recipient to view documents/sections that do not concern the recipient or by allowing a recipient to view tracked interaction data associated with the document (e.g., an audit trail). In another example, a third-party subcontractor to a contract views information (e.g., contact information, signature(s), etc.) associated with another party (e.g., a customer) even though there is no need for the subcontractor to have access of such information. This is undesirable as the contractor often does not want the subcontractor to know the identity of the customer. To avoid this type of information transfer, a document originator manually controls information access by, for example, providing separate documents to corresponding parties from which review is needed. This type of manual control is costly to the originator as it necessitates maintaining an association between the separate documents. In some cases, the originator stores (electronically and/or physically) the documents in a common location (e.g., an electronic/physical file folder). In additional to increasing the maintenance overhead for the originator, current techniques can easily lead to document loss, potentially resulting in negative legal and financial consequences.

### SUMMARY

As discussed above, existing document management systems provide all documents for multi-document signature workflows to all signatories. In doing so, confidential party information is often exposed to signatories unnecessarily. According to certain embodiments, systems and methods are disclosed for controlling access to document information relating to a document management project. By providing these workflows, a user is enabled to manage a computer-automated multi-party, signature workflow by defining workflow attributes (information and tasks) for particular users so that the system can automatically provide documents and obtain signatures without exposing confidential information to parties that don't need access to such information. For example, a user is enabled to define one or more internal workflows (to collect signatures from people within the user's organization) and/or one or more external workflows (to collect signatures from people outside of the user's organization). In accordance with at least one embodiment, providing multiple workflows related to a document management project allows a user to manage access control to sensitive information and enables tracking of multiple related documents.

In some embodiments, user-specified input related to a document management project is received. The user-specified input comprises a first set of attributes that define a first set of tasks and accessible information of a first workflow and a second set of attributes that define a second set of tasks and accessible information of a second workflow. A first document is provided for signature and related information to a first individual by executing one or more instructions of the first workflow according to the first set of attributes. A second document is provided for signature and related information to a second individual by executing one or more instructions of the second workflow according to the second set of attributes. Progress of the first workflow execution and the second workflow execution is tracked. Information related to the tracked progress is provided. The tracked progress of the first workflow is accessible to the first individual and the tracked progress of the second workflow is accessible to the second individual

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE FIGURES

Features, embodiments, and advantages of the present disclosure are better understood when the following Detailed Description is read with reference to the accompanying drawings, where:

FIG. 1 is a block diagram depicting an example of a document workflow manager that tracks progress of a document management project, according to certain exemplary embodiments;

FIG. 2 is an example computer architecture of the document workflow manager of FIG. 1, including a plurality of modules that are utilized to provide various aspects of the document workflow manager, according to certain exemplary embodiments;

FIG. 3 is a schematic diagram depicting an example interface provided by the document workflow manager of FIGS. 1 and 2, according to certain exemplary embodiments;

FIG. 4 is a schematic diagram depicting an example interface for specifying one or more dependencies, according to exemplary embodiments of the document workflow manager of FIGS. 1 and 2;

FIG. 5 a schematic diagram depicting an example interface for displaying one or more workflows, according to exemplary embodiments of the document workflow manager of FIGS. 1 and 2;

FIG. 6 is a flow chart depicting an example process for providing a number of workflows related to a document management project, according to certain exemplary embodiments;

FIG. 7 is a flow chart depicting another example process for providing a number of workflows related to a document management project, according to certain exemplary embodiments;

FIG. 8 is a flow chart depicting still one further example process for providing a number of workflows related to a document management project, according to certain exemplary embodiments; and

FIG. 9 is a block diagram depicting an example of a computing device that executes the document workflow manager according to certain exemplary embodiments.

### DETAILED DESCRIPTION

According to certain embodiments, systems and methods are disclosed for providing a number of workflows related to a document management project. As discussed above, existing document management techniques fail to maintain the confidentiality of certain document information or require the user to manually maintain associations between documents in a collection. Techniques are disclosed herein for managing access control and workflow execution related to a collection of electronic documents (e.g., a document management project). A “workflow,” as used herein is intended to refer to a sequence of computer-executable tasks that are necessary to complete an user-defined activity. Specifically, a document management engine is provided that tracks, manages, disseminates, and/or stores electronic documents on behalf of a user. In at least one example, dissemination of a document elicits a signature from one or more users.

As used herein, a “document management system” is intended to refer to a system that tracks, manages, disseminates, and/or stores electronic documents on behalf of a user. An “audit trail,” as used herein is intended to refer to a record that provides information regarding one or more versions of a document and/or one or more modifications made to the document by a number of users.

In accordance with at least one embodiment, an interface is provided (e.g., via a web page) for specifying a number of internal and/or external workflows. In at least one example, an internal workflow includes activities that are to be conducted by an individual associated with a document originator (e.g., an approval manager, a legal representative, etc.). An external workflow includes activities that are to be conducted by an outside party (e.g., a customer, a subcontractor, a vendor, etc.). In at least one example, a workflow includes both internal and external activities.

In a non-limiting example, a system and/or method for providing a number of workflows related to a document management project provides an interface (e.g., a webpage) to enable a user to define a workflow. In at least one example, the user utilizes the interface to define a document management project (e.g., related to a business contract) that includes a number of workflows (e.g., one or more external workflows and/or one or more internal workflow). A workflow includes a number of tasks to be executed on behalf of the user. A document management request is received that includes user-specified input defining the document management project and a number of workflows. A set of attributes are received via the document management request that relates to a workflow (e.g., an internal workflow). Each of the set of attributes includes, but is not limited, one or more recipients, one or more document identifiers (e.g., document pathnames), a message, a signature option (e.g., electronic signature required), and a number of dependencies. The document management request is submitted using an interface provided by the document workflow manager described herein. A workflow specification is generated for each set of attributes corresponding to each workflow. A workflow specification associates the set of attributes with a workflow identifier. In at least one example, the workflow specification additionally includes an association between the workflow identifier and a document management project identifier. In accordance with at least one embodiment, one or many workflow specifications are associated with a single document management project. The workflows are executed according to the associated workflow specification (e.g., according to the set of attributes). The progress for each workflow is tracked and provided (or a portion provided) to the user for review. In at least one example, a workflow (or a task) is associated with various dependencies (e.g., related to another workflow, related to a portion of a workflow, etc.).

In at least one example, a document management request includes user-specified attributes for an internal workflow and user-specified attributes for an external workflow. A workflow specification is generated for the internal workflow and another workflow specification is generated for the external workflow. In at least one example, a single workflow specification is generated to include user-specified attributes for each workflow. A workflow specification includes an association to the document management project referenced in the request. One or more tasks of the workflow are executed according to the workflow specification. For example, a workflow specification corresponding to an internal workflow indicates that a particular document is to be sent an individual (e.g., a manager) for approval. The workflow specification corresponding to the external workflow indicates that another document is to be provided to another individual (e.g., a customer). The documents are sent to the designated recipient upon execution of a corresponding workflow. In at least one example, the workflow includes a number of user-specified dependencies. One such dependency specifies that the document will not be sent to the customer, until the manager signs the other document. At some point, the manager accesses the document and electronically signs. The manager's access and/or signing is recorded as an entry in an audit trail associated with the document management workflow. In at least one example, the signing entry is labeled as being associated with the internal workflow. The document, in this example, is then sent to the customer. In some implementations, when an event in a workflow causes a transition in a dependent workflow, such as the manager signing event satisfying the dependency in the external workflow, the event that caused the transition is recorded and identified as the cause in the audit trail. Such an entry in the audit trail related to transitioning dependent workflows (e.g., signing in the internal workflow transitions the external workflow) may be visible only to users having access to each of the associated workflows, such as an originator of the workflows wishing to verify that the transition in the external workflow was valid. Upon opening the document and/or upon viewing progress related to the document, the customer views recorded progress that is labeled with the workflow to which the customer belongs. Other progress labeled with other workflows are not visible to the customer. Likewise, in the document, any information associated with the manager is hidden from the customer based on the association between the customer and a workflow that is different than the workflow associated with the manager.

In at least one example, an access request for one of the disseminated documents is received (e.g., from a recipient of one of the disseminated documents). The workflow specification associated with the document for which access is being requested is retrieved. A user identifier and the workflow specification are utilized to determine whether or not the user should be provided access to the document. If the user identifier is not associated with the workflow specification, the access request is denied and the document is not provided. If the user identifier is associated with the workflow specification, the user is provided access to the document (e.g., to the whole of the document or to a portion of the document) according to the workflow specification. The user indicates that a task has been completed.

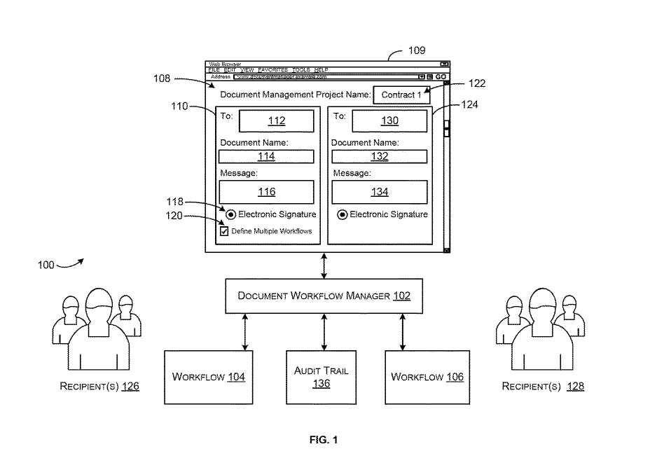

Referring now to the drawings, FIG. 1 is a block diagram 100 depicting an example of a document workflow manager 102 that provides a number of workflows (e.g., workflow 104 and workflow 106). An interface (e.g., a webpage 108 associated with a website 109) is provided by the document workflow manager 102 to collect various attributes associated with the workflow 104 and/or the workflow 106.

For example, the document workflow manager 102 provides to a user a webpage associated with the website 108. In at least one example, the user is provided an interface element section 110 related to a first workflow. The interface element section 110 may include a number of interface elements including, but not limited to, edit box 112 (e.g., corresponding to a recipient field), edit box 114 (e.g., corresponding to a document identifier field), edit box 116 (e.g., corresponding to a message field), an electronic signature option 118 (e.g., corresponding to an option requiring the recipient(s) to sign the identified documents), and a multiple workflow option 120 (e.g., corresponding to an option for providing additional interface elements corresponding to an additional workflow).

In at least one embodiment, the user selects the multiple workflow option 120 (e.g., by selecting a checkbox or other graphical element). In at least one embodiment, an edit box or other graphical element is provided to enable the user to indicate that one or more workflows are needed. The user, upon selecting the multiple workflow option 120 (or another applicable graphical element), is presented with an edit box 122 (e.g., corresponding to a document management project name) and an interface element section 124. In at least one example, the user is provided with multiple additional interface element sections, each corresponding to a distinct workflow.

The user, at any suitable time, may provide a set of attributes related to a workflow (e.g., the workflow 104) by utilizing the graphical elements of interface element section 110. In at least one example, the user specifies a number of recipients (e.g., recipients 126) for the workflow 104 via the edit box 112. The user specifies the document name(s) for the workflow 104 via the edit box 114. The user specifies a message for the recipient(s) 126 via the edit box 116. The user specifies that the recipient(s) 126 are requested to electronically sign the document by selecting the electronic signature option 118.

In at least one embodiment, the user, upon selecting the multiple workflow option 120, is presented with edit box 122 an the interface element section 124 (e.g., corresponding to the workflow 106). In at least one example, the user specifies a number of recipients (e.g., recipient(s) 128) for the workflow 106 via the edit box 130. The user specifies the document name(s) for the workflow 106 via the edit box 132. The user specifies a message for the recipient(s) 128 via the edit box 134. The user specifies that the recipient(s) 128 are requested to electronically sign the document by selecting the electronic signature option 134.

In at least one example, the document workflow manager 102 executes the workflow 104 and the workflow 106 according to the user-specified input provided via the interface element section 112 and the interface element section 124, respectively. For example, the document workflow manager 102 provides the documents specified in edit box 114 to the recipient(s) 126 (e.g., via website 108). In at least one embodiment, the document workflow manager 102 notifies the recipient(s) 126 of the availability of the documents. The recipient(s) 126, in some examples, interact with the document(s) (e.g., access, sign, etc.) using another webpage provided by the document workflow manager 102 (e.g., another webpage of the website 109). The document workflow manager 102 tracks interactions between the recipient(s) 126 and the document(s) (e.g., access actions indicating that a recipient has access a document, signing actions indicating that a recipient has signed a document, etc.). The document workflow manager 102 records such interactions (e.g., via the audit trail 136).

Similarly, the document workflow manager 102 provides the documents specified in edit box 132 to the recipient(s) 128 (e.g., via website 108). In some examples, the one or more documents may be common between the workflow 104 and the workflow 106. In at least one embodiment, the document workflow manager 102 notifies the recipient(s) 128 of the availability of the documents. The recipient(s) 12/, in some examples, interact with the document(s) (e.g., access, sign, etc.) using another webpage provided by the document workflow manager 102 (e.g., another webpage of the website 109). The document workflow manager 102 tracks interactions between the recipient(s) 128 and the document(s) (e.g., access actions indicating that a recipient has access a document, signing actions indicating that a recipient has signed a document, etc.). The document workflow manager 102 records such interactions (e.g., via an audit trail 136).

In at least one embodiment, the recipient(s) 126 cannot access information regarding workflow 106, including information related to the recipient(s) 128 from the documents provided and/or from the audit trail 136. Likewise, the recipient(s) 128 cannot access information regarding workflow 104, including information related to the recipient(s) 126, from the documents provided and/or from the audit trail 136. In at least one embodiment, the user may access any information pertaining to workflow 104 and/or the workflow 106, via the documents provided and/or the audit trail 136. Upon detecting an interaction (e.g., access and/or signing) between one of the recipient(s) 126 and/or one of the recipients 128 with provided document(s), the document workflow manager 102 notifies the user of the interaction (e.g., via an email, a text message, or any suitable form of electronic communication).

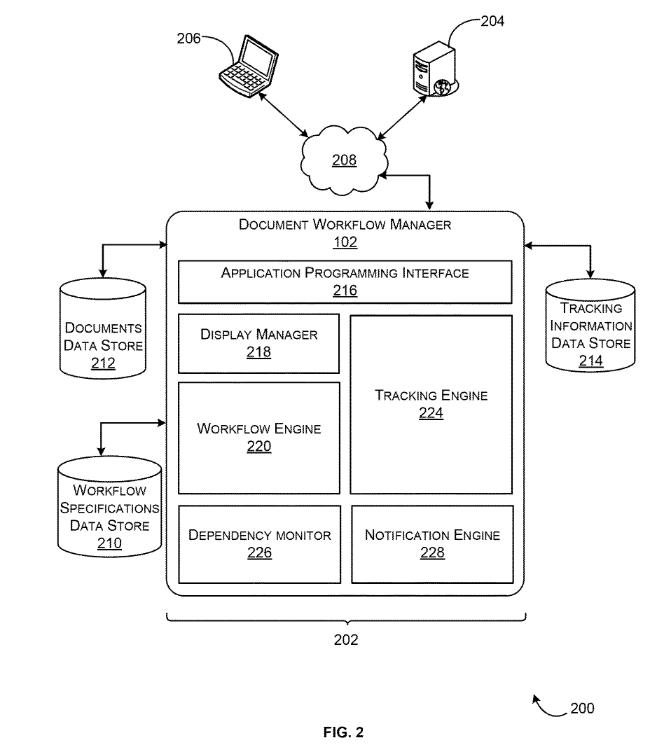

FIG. 2 is an example computer architecture 200 of the document workflow manager 102 of FIG. 1, including a plurality of modules 202 that are utilized to provide various aspects of the document workflow manager 102, according to certain exemplary embodiments. The modules 202 are software modules, hardware modules, or a combination thereof. In some examples, the modules 202 are embodied on a computer readable medium and processed by a processor in any of the computer systems described herein. The modules 202 are configured in the manner suggested in FIG. 2 or the modules 202 are configured in a different configuration. Alternatively, the modules are external to the document workflow manager 102. In some examples, at least one of modules 202 is executed, in whole or in part, on service provider computer(s) 204 (e.g., a server). In some examples, a user computing device 206 and/or the service provider computer(s) 204 interact with the document workflow manager 102 via network 208. The network 208 (and any network described herein) includes any appropriate set of communicatively-coupled computing devices and equipment that electronically transmit and receive data. Examples of the network 208 include (but are not limited to) an intranet, the Internet, a cellular network, a local area network, a wide area network, or any other such network or combination thereof.

In at least one embodiment, the user computing device 206 may be any suitable type of computing device such as, but not limited to, a mobile phone, a smartphone, a personal digital assistant (PDA), a laptop computer, a desktop computer, a thin-client device, a tablet PC, an electronic book (e-book) reader, etc. In some examples, the user computing devices 204 may be in communication with the service provider computer(s) 204 via the networks 208, or via other network connections. In some aspects, the service provider computer(s) 204 may also be any suitable type of computing device such as, but not limited to, a mobile phone, a smart phone, a personal digital assistant (PDA), a laptop computer, a desktop computer, a server computer, a thin-client device, a tablet PC, etc. The service provider computer(s) 204 may include one or more servers, perhaps arranged in a cluster, as a server farm, or as individual servers not associated with one another. These servers may be configured to implement the content performance management described herein as part of an integrated, distributed computing environment.

In the embodiment shown in FIG. 2, a workflow specifications data store 210, a documents data store 212, and a tracking information data store 214 are shown. It should be understood that data can be otherwise maintained, derived, or accessed from various data stores. Such data stores are either remote or local to the document workflow manager 102. A combination of the data stores depicted in FIG. 2 are located on the service provider computer(s) 204 and/or are located on the user device(s) 204. The document workflow manager 102 includes various modules such as an application programming interface 216, a display manager 218, a workflow engine 220, a tracking engine 224, a dependency monitor 226, and a notification engine 228. In some examples, the modules 202 are combined in any suitable combination. Some functions of the modules 216, 218, 220, 222, 224, 226, and 228 are described below. However, for the benefit of the reader, a brief, non-limiting description of each of the modules is provided in the following paragraphs.

The application programming interface 216 is utilized by the document workflow manager 102 to receive and/or transmit any suitable information (e.g., user-specified input), for example, between the document workflow manager 102 and the user device 206 via the network 208. Additionally, or alternatively, the application programming interface 216 is utilized to receive and/or transmit any suitable information between the service provider computer(s) 204 and the document workflow manager 102.

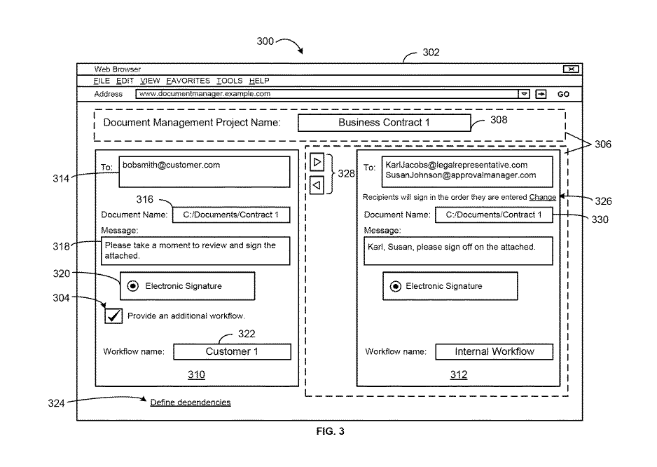

In accordance with at least one embodiment, the display manager 218 is configured to provides one or more webpages (e.g., the webpage 108 of FIG. 1 of the website 109 of FIG. 1). For example, the display manager 218 may provide the webpage 108 in order to provide various interface elements (e.g., the interface element section 110 and corresponding interface elements and/or the interface element section 124 and corresponding interface elements). Additionally, the display manager 218 is configured to provide the interfaces discussed below in connection with FIGS. 3, 4, and 5.

In accordance with at least one embodiment, the workflow engine 220 is configured to receive user-specified input (e.g., a number of sets of attributes corresponding to individual workflows and/or a number of documents corresponding to individual workflows). The sets of attributes each identify one or more documents stored in the documents data store 212. Alternatively, the user-specified input includes one or more documents. The workflow engine 220 stores received documents in the documents data store 212, a data store configured to store such data. The workflow engine 220 generates a number of workflow specifications corresponding to the number of sets of attributes received. In at least one example, the workflow engine 220 stores each workflow specification in the workflow specifications data store 210, a data store configured to store such information. In at least one example, the workflow engine 220 conveys information to the dependency monitor 226 corresponding to a number of dependencies specified by the received user-specified input. In at least one embodiment, the workflow engine 220 executes instructions corresponding to the workflows in accordance with the received user-specified input. For example, the workflow engine 220 disseminates one or more documents to one or more recipients specified in a particular workflow. In at least one example, dissemination is triggered by the dependency monitor 226.

In accordance with at least one embodiment, the dependency monitor 226 receives (e.g., from the workflow engine 220) a number of dependencies corresponding to various workflows. In another embodiment, the dependency monitor 226 receives information (e.g., one or more workflow identifiers from the workflow engine 220) corresponding to one or more workflows for which dependencies exist. The dependency monitor 226 utilizes such information to determine a number of dependencies related to one or more workflows. In a non-limiting example the dependency monitor 226 determines (e.g., from dependency information included in a workflow specification) that a document is not to be disseminated to various recipients (e.g., the recipient(s) 126) until other recipients (e.g., the recipient(s) 124 of FIG. 1) have accessed and/or signed the document. The dependency monitor 226, in some examples, causes the workflow engine to disseminate a document based on information received from the tracking engine 224 indicating that an action has taken place (e.g., the recipient(s) 124 have accessed and/or signed the document).

In accordance with at least one embodiment, the tracking engine 224 receives (e.g., from the workflow engine 220) information (e.g., one or more workflow specification identifiers) corresponding to one or more workflows for which tracking is needed. The tracking engine 224 monitors interactions between a recipient (e.g., of the recipients 126 and/or the recipients 128) in order to ascertain when the recipient has accessed and/or signed a document. The tracking engine 224 stores information related to the interaction(s) in, for example, the tracking information data store 214, a data store configured to store such information. In at least one example, the information related to the interaction(s) is recorded (e.g., in the audit trail 136 of FIG. 1). The record is associated with one or more workflows (e.g., the workflow 104 and/or the workflow 106). The tracking engine 224 labels each interaction with one or more workflow identifiers corresponding to one or more workflows to which the interaction pertains.

In accordance with at least one embodiment, the notification engine 228 receives information from the workflow engine 220 corresponding to indications that a document has been disseminated. Additionally, or alternatively, the notification engine 228 receives information from the tracking engine 224 indicating that a document has been accessed and/or signed. The notification engine 228 is configured to provide one or more notifications regarding status of the document (e.g., disseminated, accessed, signed, etc.) to one or more individuals (e.g., the user, the recipient(s) 124, the recipient(s) 126, etc.). In a non-limited example, the notification engine 228 may notify the recipient(s) 124 that a document is accessible (e.g., via a webpage of website 109 of FIG. 1). A recipient may access and sign the document. The notification engine 228 receives information from the tracking engine 224 that the recipient has been accessed/signed. The notification engine 228 records the interaction and notifies the user that the document has been accessed/signed by the recipient.

FIG. 3 is a schematic diagram depicting an example interface 300 provided by the document workflow manager 102 of FIGS. 1 and 2, according to certain exemplary embodiments. The example interface 300, in this example, is provided via webpage 302 (e.g., a webpage of the website 109 of FIG. 1). The webpage 302 is provided by the display manager 218 of FIG. 2. A user (e.g., an originator of a document project) may select an option (e.g., indicated by checkbox 304) to indicate that he intends on specifying multiple workflows. It should be appreciated that although a checkbox is used in this example, other embodiment utilize different graphical elements (e.g., a radio button, an edit box for specifying a number of additional workflows, etc.). Upon selection of the option to specify multiple workflows, the user is presented interface elements 306. In accordance with at least one embodiment, the user provides a document management project name (e.g., a document management project identifier such as “Business Contract 1”) utilizing an edit box 308. In at least one example, the document management project identifier is any suitable combination of alphanumeric characters.

In accordance with at least one embodiment, the user utilizes interface element section 310 to specify a set of attributes for a workflow (e.g., the workflow 104 of FIG. 1). For example, the user specifies a recipient (e.g., using an email address such as bobsmith@customer.com) using the edit box 314. The recipient, in this case, corresponds to a customer of a contract. In at least one embodiment, the user specifies one or more recipients using a drop down menu that user to select from a number of contacts (including Bob Smith, a contact corresponding to the address bobsmith@customer.com). The user specifies one or more documents utilizing edit box 316. In at least one embodiment the user specifies the one or more documents using another interface elements such as a browse button that provides an interface for navigating to a location of a document on the user's computing device (e.g., the user computing device 206 of FIG. 2). The one or more documents are listed edit box 316 and/or in another portion of the interface element section 310. In accordance with at least one embodiment, the user specifies a text message utilizing the edit box 318. In some examples, the edit box 318 limits the user to a particular number of words/characters. In at least one embodiment, the user selects an option 320 to indicate that the recipient (bobsmith@custorner.com) is requested to electronically sign the document. Other signature options may be utilized.

In accordance with at least one embodiment, the document workflow manager 102 provides edit box 322 to a user. Edit box 322 is utilized by the user to specify a name for the workflow corresponding to the interface element section 310. In accordance with at least one embodiment, a workflow name is any suitable combination of alphanumeric characters.

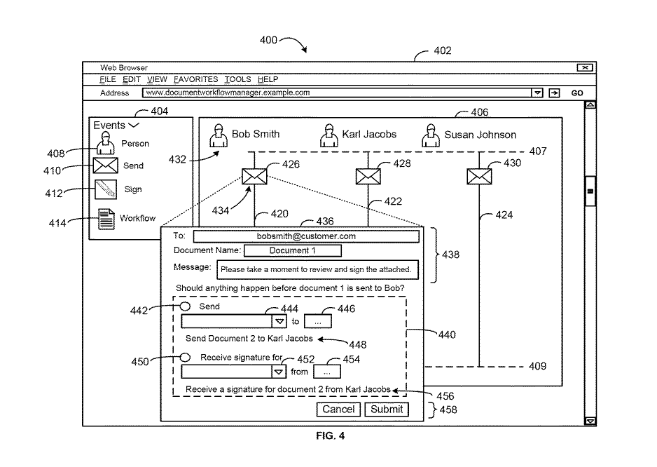

In at least one embodiment, the document workflow manager 102 provides an option (e.g., indicated by hyperlink 324) to define a number of dependencies (e.g., between workflows and/or between workflow tasks). In at least one example, selection of hyperlink 324 causes the document workflow manager 102 to provide one or more additional interfaces (e.g., the interface 400 discussed below in connection with FIG. 4). In some example, the user defines dependencies using a different interface element (e.g., a checkbox, an edit box, a radio button, etc.). For example, the user may be presented a checkbox. Upon selection of the checkbox, the user is presented an interface for defining a number of dependencies (e.g., an edit box with which the user can type in a dependency such as “send karljacobs@legalrepresentative.com and susanjohnson@approvalmanager.com C:/Documents/Contract 1 when bobsmith@customer.com signs C:/Documents/Contract 1). In some examples, a dependency is specified using a combination of edit boxes and/or drop down menus, and/or radio buttons, and/or checkboxes, etc. Dependencies, in some examples are in list form, while in other examples, the dependencies are display in a graphical representation of a workflow.

According to some embodiments, the user is provided interface element section 312 for specifying various attributes associated with another workflow (e.g., the workflow 106 of FIG. 1). The interface elements provided in interface element section 312 are similar to those provided in interface element section 310. In cases where multiple recipients are specified, an option 326 is provided that allows the user to change an order by which the document(s) will be provided to the recipients. In at least one example, selecting the option 326 provides the user with an interface that enables the user to modify the order of the recipients and/or specify that the users are to be provided the document(s) simultaneously. In at least one example, user interface buttons 328 are provided by the document workflow manager 102 to enable a user to copy information from interface element section 310 to interface element section 312 and vice versa. As a non-limiting example, the user selects the edit box 316 and then the right arrow button of user interface buttons 328 to copy the document name from edit box 316 into the edit box 330.

It should be appreciated that the interface 300 is merely one example interface provided by the document workflow manager 102, and other interfaces may be provided to enable a user to specify attributes associated with one or more workflows.

FIG. 4 is a schematic diagram depicting an example interface 400 for specifying one or more dependencies, according to exemplary embodiments of the document workflow manager 102 of FIGS. 1 and 2. In accordance with at least one embodiment, a user selects an option to define one or more dependencies (e.g., by selecting hyperlink 324 of FIG. 3). Upon making such a selection, the document workflow manager 102 provides the user with various interface elements via webpage 402 (e.g., a webpage included in the website 109 of FIG. 1). In some embodiments, the webpage 402 includes action menu 404 and workflow definition area 406. The action menu 404 provides the user a number of action icons from which to choose. For example, the action icon 408 depicts a person (e.g., a recipient). The action icon 410 depicts a send action. The action icon 412 depicts a signing action. The action icon 414 depicts a workflow. More or fewer action icons associated with the same or other actions may be provided in some embodiments.

In accordance with at least one embodiment, the workflow definition area 406 provides space for the user to, for example, drag and drop one or more of the icons provided in action menu 404. In at least one example, upon selecting an option to define one or more dependencies, the workflow definition area 406 is automatically populated with a timeline associated with each recipient. A timeline depicts an earliest time at location 407 and a latest time at location 409. For example, the recipients from FIG. 3 are each provided a timeline corresponding to timeline 420, timeline 422, and timeline 424. Each timeline is labeled as corresponding to a recipient (e.g., Bob Smith, Karl Jacobs, Susan Johnson, respectively). In at least one example, the timeline 420, the timeline 422, and the timeline 424 are automatically populated with send actions (e.g., corresponding to the send icon 426, the send icon 428, and the send icon 430, respectively. The send actions correspond to the document(s) specified with edit box 316 of FIG. 3 (for Bob Smith) and the document(s) specified with edit box 330 (for Karl Jacobs and Susan Johnson).

In other embodiments, the workflow definition area 406 is initially empty, leaving the user to define individual timelines. In these examples, the user may drag and drop the action icon 408 to location 432 in order to create the timeline 420. Similar actions may be taken by the user to define the timeline 422 and/or the timeline 424. In accordance with at least one embodiment, the user may drag and drop any number of action icons along a timeline in order to specify a dependency. For example, the user may drag and drop the action icon 410 to location 434 in order to define a send action. Upon dropping the action icon 410 to location 434, or upon selection of an action item 426, interface 436 is provided to the user by the document workflow manager 102. The interface 436, in this example, is depicted as a pop-up window, although the interface 436 may alternatively be provided as a separate webpage.

In accordance with at least one embodiment, the interface 436 may include information 438 from the interface element section 310 of FIG. 3 (e.g., user-specified data 328). The interface 436 further includes dependency section 440, which includes one or more interface elements for defining a dependency. For example, the dependency section 440 depicted in FIG. 4 provides an option 442 for defining a send dependency. The user, upon selection the option 442, utilizes drop down menu 444 for selecting one or more documents. Alternatively, the documents may be listed and the user can select one or more documents from the list. In the example depicted in FIG. 4, the user utilizes selection button 446 to select a number of recipients. For example, upon selectin the selection button 446, the names of Karl Jacobs and Susan Johnson become selectable. Alternatively, the user is presented an edit box to type in a recipient's name/address. In yet another example, the user is presented a list of users from which to select one or more users. Upon making a selection from the drop down menu 444 and a recipient using the selection button 446, a corresponding dependency rule is displayed, for example, at 448. In the example depicted in FIG. 4, the user has specified that document 2 should be sent to Karl Jacobs before document 1 is sent to Bob Smith.

In accordance with at least one embodiment, the user utilizes option 450, drop down menu 452, and selection button 454 in a similar manner as described above to define a dependency rule associated with a signature. In this example, the user has specified that a signature for document 2 must be received from Karl Jacobs before document 1 is sent to Bob Smith. This information is displayed at 456. The user selects one of buttons 458 in order to submit or cancel his defined dependencies.

In accordance with at least one embodiment, the drop down menu 444 and the selection button 446 are not displayed until the option 442 is selected. Similarly, the drop down menu 452 and the selection button 454 are not displayed until the option 450 is selected.

In accordance with at least one embodiment, dependencies between workflows may be similarly define. When the user drags and drops the action icon 414 to the workflow definition section 406, a timeline corresponding to a workflow is created. The user may drag multiple instances of the action icon 414 to define multiple workflows (e.g., the workflow 104 and the workflow 106 of FIG. 1). In these examples, the user selects a workflow icon displayed on a timeline in order to further define dependencies of the workflow. An interface similar to that of the interface 436 is provided by the document workflow manager in order to define a number of dependencies for the workflow.

It should be appreciated that the specific interface elements depicted in FIG. 4 are meant to be illustrative in nature and are not meant to limit the number and/or types of interface elements that may be provided to the user by the document workflow manager 102.

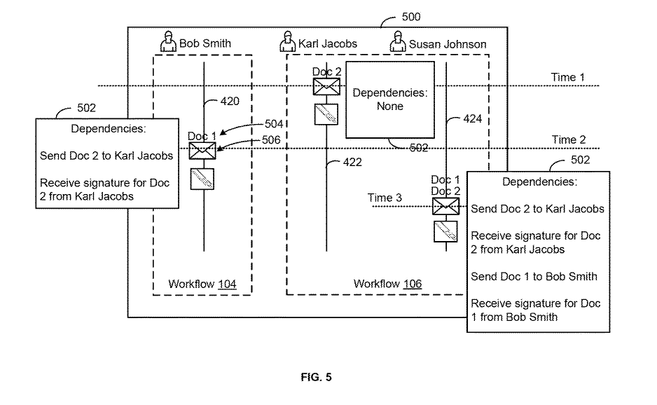

FIG. 5 a schematic diagram depicting an example interface 500 for displaying one or more dependencies, according to exemplary embodiments of the document workflow manager 102 of FIGS. 1 and 2. The interface 500 is provided, for example, via a webpage provided by the document workflow manager 102. In at least one embodiment, the document workflow manager 102 may depict the timeline 420 corresponding to Bob Smith, the timeline 422 corresponding to Karl Jacobs, and/or the timeline 424 corresponding to Susan Johnson. The timelines 420, 422, and/or 424, including at least some of the action icons depicted on each timeline are, in some examples, automatically generated by the document workflow manager 102 according to user-specified input (e.g., corresponding to an order defined for recipients utilizing the hyperlink 326 of Figure and/or the dependency rules specified via the interface 436 of FIG. 4).

A non-limiting example is given in FIG. 5. In the example provided, various dependencies between actions associated with a recipient are depicted. For example, a document (e.g., document 2) is specified to be sent first and a signature is required for document 2 from Karl Jacobs before document 1 is sent to Bob smith. Similarly, document 1 must be signed by Bob smith and document 2 must be signed by Karl Jacobs before documents 1 and 2 are sent to Susan Johnson. Actions defined for Karl Jacobs and Susan Johnson depict an example workflow (e.g., the workflow 106, an internal workflow). Similarly, the actions defined for Bob Smith depict another example workflow (e.g., the workflow 104, an external workflow). The dependencies for each action are displayed in text blocks (e.g., the text boxes 502) as depicted in FIG. 5, or the dependencies are displayed in a different fashion, or not at all. Actions are labeled as depicted in FIG. 5 at 504, or actions are labeled in a different manner (e.g., as a pop-up label when the user hovers over an action icon such as the action icon 506).

Workflow timelines (e.g., specified by the user, or automatically generates by the document workflow manager 102) may be depicted as timelines in a similar manner as depicted in FIG. 5. In such examples, each workflow has a corresponding timeline and action icons are displayed along each timeline to depict a general flow of document dissemination (e.g., send actions) and signing actions in relation to other actions of the workflows.

In accordance with at least one embodiment, dependencies between recipients and/or workflows are displayed to the user in a list or other representation. The user, in some examples, may specified exact times/dates upon which an action is to be taken. Thus, in some examples, the timeline/list may correspond to a time period and the action icons/list entries may correspond to particular dates/times. For example, an action corresponding to sending document 2 to Karl Jacobs may be defined/scheduled to be disseminated at time 1 (Mar. 1, 2016, at 1:00 PM PST). Similarly, an action corresponding to sending document 1 to Bob Smith may be defined/scheduled to be disseminated at time 2. An action corresponding to sending documents 1 and 2 to Susan Johnson may be defined/scheduled to be disseminated at time 3. In some examples, time 3 is a later date/time than time 2, which is a later date/time than time 1.

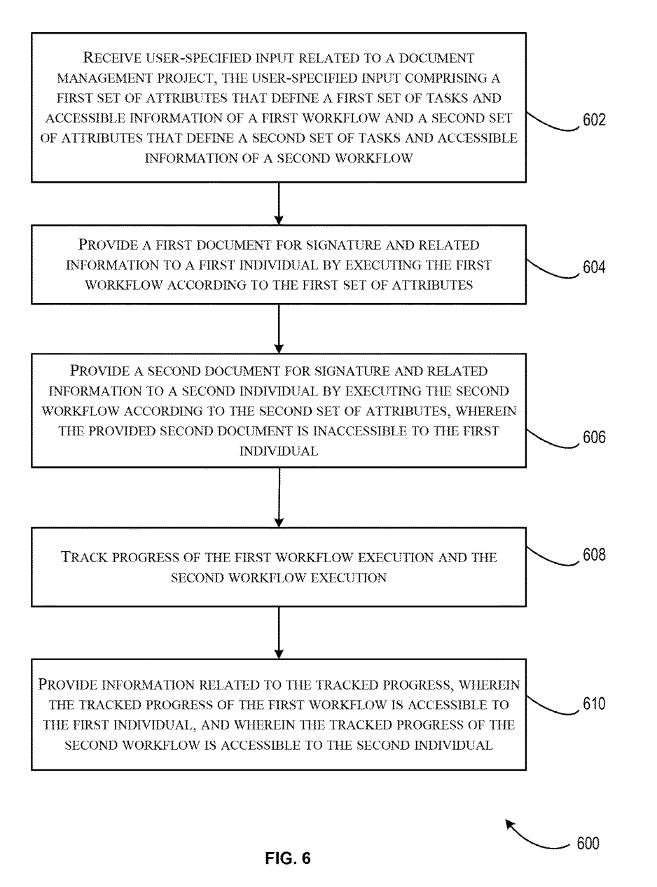

FIG. 6 is a flow chart depicting an example process 600 for providing a number of workflows related to a document management project, according to certain exemplary embodiments. In some embodiments, some or all of the various activities of the process 600 related to receiving or providing data are accomplished through communication with one or more other computing devices via an application programming interface (“API”) disclosed herein. The process begins at block 602 where user-specified input related to a document management project is received (e.g., by the workflow engine 220 of FIG. 2). The user-specified input comprises a first set of attributes that define a first set of tasks and accessible information of a first workflow and a second set of attributes that define a second set of tasks and accessible information of a second workflow. In at least one example, the first set of tasks includes disseminating one or more document to a one or more persons. Additionally, accessible information details that a portion of a document, or a whole document, is accessible to the person or is inaccessible to the person.

At block 604, a first document is provided (e.g., by the workflow engine 220) to a first individual by executing the first workflow according to the first set of attributes. The first document is provided to obtain signature and related information.

At block 606, a second document is provided (e.g., by the workflow engine 220) to a second individual by executing the second workflow according to the second set of attributes. The second document is provided to obtain signature and related information. In at least one example, the second document provided is inaccessible to the first individual.

At block 608, progress of the first workflow execution and the second workflow execution is tracked (e.g., by the tracking engine 224 of FIG. 2). For example, the tracking engine 224 records (e.g., in an audit trail) when the first individual opens and/or signs a document. Similarly, the tracking engine 224 records (e.g., in the audit trail) when a second individual opens and/or signs a document.

At block 610, information related to the tracked progress is provided (e.g., by the display manager 218 and/or the notification engine 228 of FIG. 2). In at least one example, the tracked progress of the first workflow is accessible to the first individual. Similarly, the tracked progress of the second workflow is accessible to the second individual.

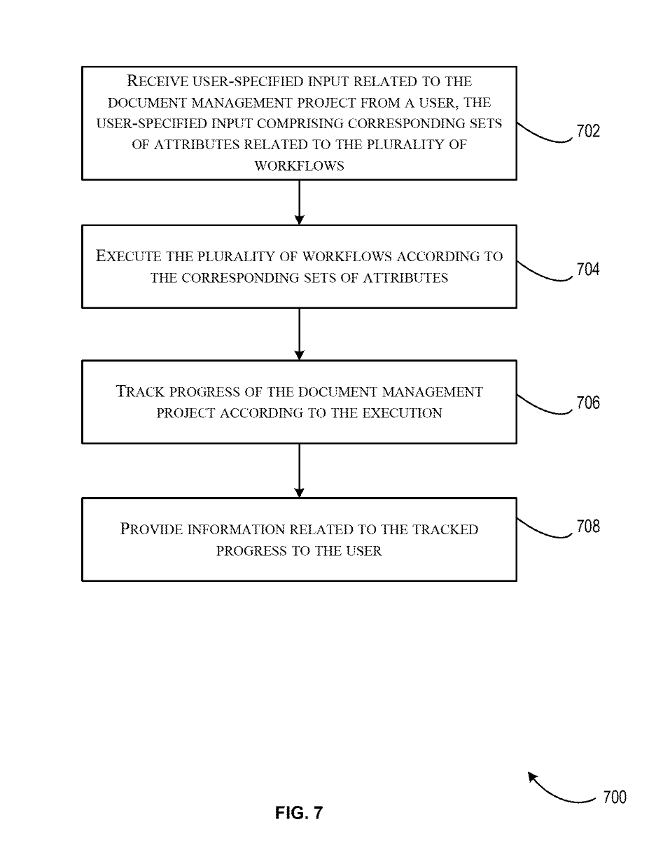

FIG. 7 is a flow chart depicting another example process 700 for providing a number of workflows related to a document management project, according to certain exemplary embodiments. The process begins at 702 where user-specified input related to the document management project is received (e.g., by the workflow engine 220 of FIG. 2) from a user. In at least one example, the user-specified input comprises corresponding sets of attributes related to the plurality of workflows.

At block 704, the plurality of workflows are executed according to the corresponding sets of attributes. For example, the workflow engine 220 of FIG. 2 executes various tasks defined by the sets of attributes. In at least one example, the workflow engine 220 disseminates one or more documents to one or more individuals in accordance with the set of attributes.

At block 706, progress of the document management project is tracked in accordance with the execution. For example, the tracking engine 224 of FIG. 2 records access made to the documents such as a recipient accessing the document on a web page provided, for example, by the display manager 218 of FIG. 2.

At block 708, information related to the tracked progress is provided to the user (e.g., by the display manager 218 or the notification engine 228 of FIG. 2). In at least one example, the user is provided the information via a document (e.g., an audit trail) or a web page suitable to display such information. In some examples, the user is notified (e.g., by the notification engine 228) that the information is available for viewing. According to at least one embodiment, information related to the tracked progress of a first workflow of the plurality of workflows is not accessible to recipients of documents of a second workflow of the plurality of workflows.

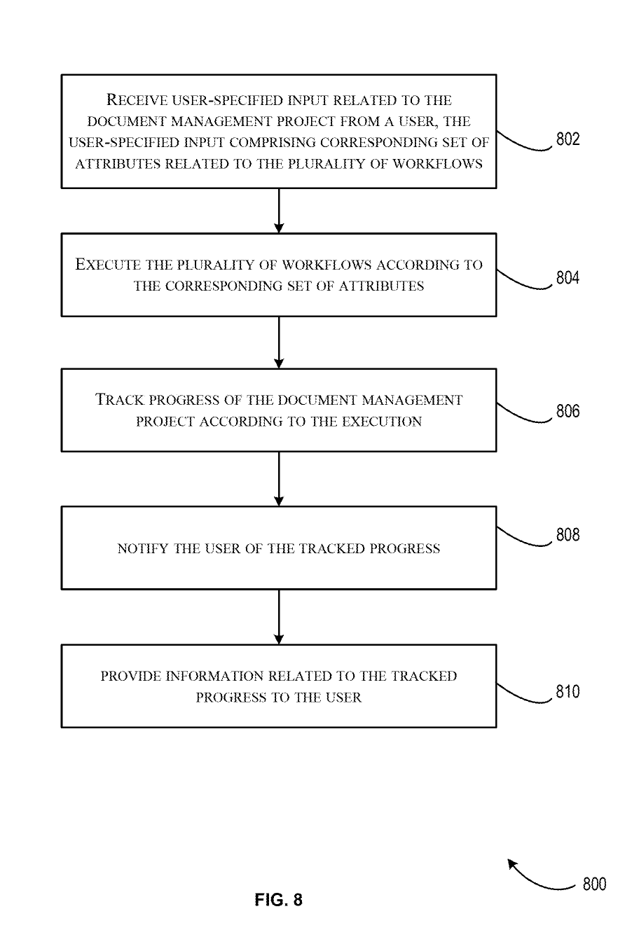

FIG. 8 is a flow chart depicting still one further example process 800 for providing a number of workflows related to a document management project, according to certain exemplary embodiments. The process 800 begins at block 802, where user-specified input related to the document management project is received (e.g., by the workflow engine 220 of FIG. 2) from a user. In at least one example the user-specified input comprises corresponding set of attributes related to a plurality of workflows. In some examples, the plurality of workflows includes one or more internal workflows and/or one or more external workflows. Each corresponding set of attributes includes one or more recipients, one or more document identifiers, and a signatory option. In some examples, the set of attributes additionally includes one or more dependencies.

At block 804, the plurality of workflows are executed according to the corresponding set of attributes. For example, one or more documents of a first workflow may be disseminated to a first set of recipients. Similarly, one or more documents of a second workflow may be disseminated to a second set of recipients. Any suitable number of documents may be disseminated to any suitable number of recipients according to any suitable number of workflows.

At block 806, the progress of the document management project may be tracked according to the execution. For example, the tracking engine 224 of FIG. 2 records access made by a recipient to a document. Similarly, the tracking engine 224 records when the recipient signs the document.

At block 810, information related to the tracked progress is provided to the user. In at least one example, the tracking engine 224 labels the tracked progress so that a recipient of one workflow cannot access records of another workflow. In some examples, the notification engine 228 notifies one or more individuals of the availability of the tracked progress.

### Exemplary Computing Environment

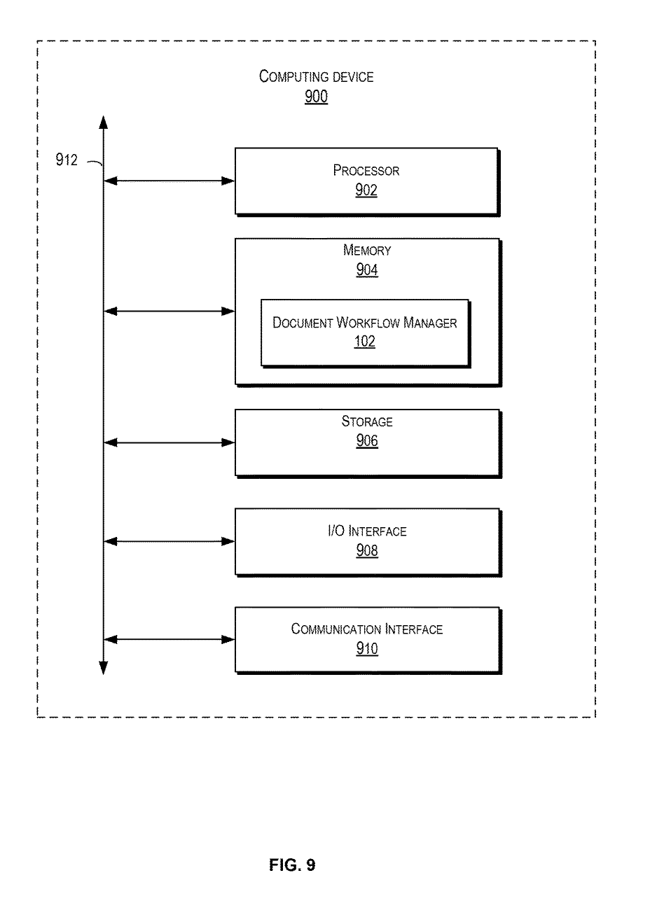

Any suitable computing system or group of computing systems can be used to implement the techniques and methods disclosed herein. For example, FIG. 9 is a block diagram depicting an example of a computing device 900 that executes the document workflow manager 102, according to certain exemplary embodiments. The computing device 900 can include a processor 902 that is communicatively coupled to a memory 904 and that executes computer-executable program code and/or accesses information stored in the memory 904 or storage 906. The processor 902 comprises a microprocessor, an application-specific integrated circuit (“ASIC”), a state machine, or other processing device. The processor 902 includes one processing device or more than one processing device. Such a processor includes or is in communication with a computer-readable medium storing instructions that, when executed by the processor 902, cause the processor to perform the operations described herein.

The memory 904 and storage 906 can include any suitable non-transitory computer-readable medium. The computer-readable medium includes any electronic, optical, magnetic, or other storage device capable of providing a processor with computer-readable instructions or other program code. Non-limiting examples of a computer-readable medium include a CD-ROM, a DVD, a magnetic disk, memory chip, ROM, RAM, an ASIC, a configured processor, optical storage, magnetic tape or other magnetic storage, or any other medium from which a computer processor can read instructions. The instructions include processor-specific instructions generated by a compiler and/or an interpreter from code written in any suitable computer-programming language, including, for example, C, C++, C#, Visual Basic, Java, Python, Perl, JavaScript, and ActionScript.

The computing device 900 also comprises a number of external or internal devices such as input or output devices. For example, the computing device 900 is shown with an input/output (“I/O”) interface 908 that can receive input from input devices or provide output to output devices. A communication interface 910 is also included in the computing device 900 and can include any device or group of devices suitable for establishing a wired or wireless data connection to one or more data networks. Non-limiting examples of the communication interface 910 include an Ethernet network adapter, a modem, and/or the like. The computing device 900 transmits messages as electronic or optical signals via the communication interface 910. A bus 912 is also included to communicatively couple one or more components of the computing device 900.

The computing device 900 executes program code that configures the processor 902 to perform one or more of the operations described above. The program code includes one or more modules. For example, the program includes the document workflow manager 102 or other suitable engine, module, or application that can be used to generate a psychographic profile of an individual. The program code is resident in the memory 904, storage 906, or any suitable computer-readable medium and executed by the processor 902 or any other suitable processor. In some embodiments, modules are resident in the memory 904. In additional or alternative embodiments, one or more modules are resident in a memory that is accessible via a data network, such as a memory accessible to a cloud service.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure the claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

1. A method for controlling access to document information related to a document management project, the method comprising:
receiving user-specified input related to the document management project, the user-specified input comprising a first set of attributes that define a first set of tasks and accessible information of a first workflow and a second set of attributes that define a second set of tasks and accessible information of a second workflow;
providing a first document for signature and related information to a first individual by executing one or more instructions of the first workflow according to the first set of attributes;
providing a second document for signature and related information to a second individual by executing one or more instructions of the second workflow according to the second set of attributes, wherein the provided second document is inaccessible to the first individual;
tracking progress of the first workflow execution and the second workflow execution; and
providing information related to the tracked progress, wherein the tracked progress of the first workflow is accessible to the first individual, and wherein the tracked progress of the second workflow is accessible to the second individual.

2. The method of claim 1, further comprising:
obtaining dependency data associated with the first workflow and the second workflow, the dependency data indicating that the first workflow depends on the second workflow, wherein the second workflow is executed before the first workflow according to the dependency data.

3. The method of claim 1, further comprising:
obtaining dependency data associated with the first workflow and the second workflow, the dependency data indicating that a first task of the first workflow depends on a second task of the second workflow, wherein the second task of the second workflow is executed before the first task of the first workflow according to the dependency data.

4. The method of claim 1, wherein providing information related to the tracked progress further comprises:
determining, from the first set of attributes that the user is associated with first work flow, wherein providing the information related to the tracked progress includes tracked process of the first workflow and excludes tracked progress of the second work flow.

5. The method of claim 1, further comprising:
storing a first workflow specification to maintain an association between the first workflow, the document management project, and the first set of attributes; and
storing a second workflow specification to maintain an association between the second workflow, the document management project, and the second set of attributes.

6. The method of claim 1, wherein the first set of attributes and the second set of attributes individually comprise one or more recipients, one or more document identifiers, one or more textual messages, and one or more dependency rules.

7. The method of claim 1, further comprising:
receiving an access request from a recipient, the access request corresponding to a document associated with the first workflow;
determining that the recipient is associated with the first workflow;
determining one or more portions of the document that are associated with the second workflow; and
excluding access to the one or more portions by the recipient.

8. The method of claim 1, further comprising:
notifying the user according to the tracked progress of the first workflow execution and the tracked progress of the second workflow execution.

9. The method of claim 1, further comprising:
labeling tracked progress according to a corresponding workflow responsible for generating the tracked progress; and
restricting access to the tracked progress according to the label.

10. The method of claim 8, further comprising:
determining a first set of dependencies associated with the first workflow;
determining a second set of dependencies associated with tasks of the first workflow;
determining a third set of dependencies associated with the second workflow;
determining a fourth set of dependencies associated with tasks of the second workflow;
generating at least one ordered list corresponding to execution of a plurality of tasks of the first workflow and the second workflow, wherein executing the first workflow is based on the at least one ordered list, and wherein executing the second workflow is based on the at least one ordered list.

11. The method of claim 1, further comprising:
providing an interface for collecting user-specified input related to a document management project, the interface enabling the user to define the first set of attributes related to the first workflow and the second set of attributes related to the second workflow.

12. The method of claim 1, wherein the tracked progress indicates that a document has been sent to a recipient, the document has been accessed by the recipient, that the document has been signed by the recipient, that the document has been accessed but remains unsigned by the recipient, or that the document has been modified by the recipient.

13. The method of claim 1, wherein first workflow is associated with internal tasks to be conducted within an entity of the user.

14. The method of claim 1, wherein the second workflow is associated with external tasks to be conducted by a recipient that is affiliated with an entity with which the user is unaffiliated.

15. The method of claim 1, where executing the first workflow comprises:
disseminating one or more documents;
notifying a recipient of the dissemination of the one or more documents;
enabling the recipient to access the one or more documents;
storing modifications made by the recipient during access; and
notifying the user of the modifications.

16. The method of claim 1, further comprising:
storing audit trail information that includes the tracked progress of the first workflow and the tracked progress of the second workflow;
receiving a request of a recipient to access the audit trail information;
determining a workflow associated with the recipient; and
generating a subset of the audit trail information to provide the recipient according to the workflow associated with the recipient.

17. The method of claim 1, wherein the document management project relates to a collection of documents, wherein the first workflow is associated with a first subset of the collection, and wherein the second workflow is associated with a second subset of the collection.

18. The method of claim 1, further comprising:
labeling an individual document of the collection of documents according to the first workflow or the second workflow to which the individual document relates; and
providing access to the individual document in accordance with the labeling.

19. A method for controlling access to document information related to a document management project, the method comprising:
receiving user-specified input related to the document management project from a user, the user-specified input comprising corresponding sets of attributes related to the plurality of workflows;
executing the plurality of workflows according to the corresponding sets of attributes;
tracking progress of the document management project according to the execution; and
providing information related to the tracked progress to the user.

20. A method for controlling access to document information related to a document management project, the method comprising:
receiving user input related to the document management project from a user, the user-specified input comprising corresponding set of attributes related to the plurality of workflows;
executing the plurality of workflows according to the corresponding set of attributes;
tracking progress of the document management project according to the execution;
notifying the user of the tracked progress; and
providing information related to the tracked progress to the user.
